(19) United States
(12) Patent Application Publication
(10) Pub. No.: US 2023/0019051 A1
(43) Pub. Date: Jan. 19, 2023

(54) Automated Interval Pacer

(71) Applicant: Digi 1st, Inc., Alhambra, CA (US)

(72) Inventor: Roger Shih, Alhambra, CA (US)

(73) Assignee: Digi 1st, Inc., Alhambra, CA (US)

(21) Appl. No.: 17/305,720

(22) Filed: Jul. 13, 2021

(51) Int. Cl. A63B 71/06; G06F 3/01; G06F 3/16

(52) U.S. Cl. CPC A63B 71/0686; G06F 3/016; G06F 3/16; A63B 2071/0625; A63B 2071/0655

(57) ABSTRACT

Implemented is an interval timer with pacer functionality (referred to herein as “interval pacer” for short), enabling a user to work out to a given pace and then automatically switches to a resting period when the pre-set pace is complete. The interval pacer may be an instantiated application on a user’s computing device, such as a smartphone, smartwatch, head-mounted display (HMD) device, etc., or may be a standalone application instantiated on a dedicated computing device specifically designed for the interval pacer application. The interval pacer application is adapted to enhance previous interval timer applications by providing a customizable pacer option which is virtually a fully customizable solution for a user to have an individualized exercise plan. In addition, the interoperation of the pacer with the interval timer enriches workout sessions by pushing the user to stick with the user-set pace for the user-designated period.

### BACKGROUND

People who exercise may leverage various tools and technology to enhance their workouts. Aside from smartwatches and other smart devices that provide analytical and sensory information, users may utilize an interval timer that overtly notifies the user of a duration of time for a given workout session and then notifies the user when the resting period is over. The interval timer alternates between a workout session and a resting session to keep track of and push themselves to maintain a consistent workout. Unfortunately, while the interval timer is a helpful exercise tool, it is also limiting in terms of its functionality.

### SUMMARY

Implemented is an interval timer with pacer functionality (referred to herein as “interval pacer” for short), enabling a user to work out to a given pace and then automatically switches to a resting period when the pre-set pace is complete. The interval pacer may be an instantiated application on a user’s computing device, such as a smartphone, smartwatch, head-mounted display (HMD) device, etc., or may be a standalone application instantiated on a dedicated computing device specifically designed for the interval pacer application. Thus, any discussion of an interval pacer application can represent an application on a user’s computing device or a dedicated device designed explicitly for workout timing.

The interval pacer, in essence, is an application that alternates between a user-designated pace and a user-designated resting period. The interval pacer may be separated by rounds, such that each round consists of a customized pace and resting period. A subsequent pace and resting period may occur immediately after the previous round’s pace and resting period. Any number of rounds can be configured, and the user may customize each round’s pace and resting period.

A pacer during a workout session helps the user maintain a given pace, or tempo, which may otherwise be difficult to maintain as the user fatigues. For example, the user may wish to execute pushups, sit-ups, pull-ups, curls, bench-presses, or various cardio exercises (running, biking, jump roping, etc.) at a given pace. The interval pacer application can help the user push himself to maintain the pace, whereas the user may unwittingly slow down without it.

The interval pacer application has several parameters that can be input by the user to customize a given workout session. For example, the interval pacer application may be configured to repeat a given customized workout session any number of times, the number of outputs (e.g., beeps, clicks, etc.) that the user wishes to receive during a pacing session, the number of outputs per minute for the pacing session, and the duration of time for the resting period. In addition, a display on the computing device may show a speed indicator that shows how fast the pacer is running. These parameters can all be input by the user to customize a given workout session. In addition, the user can customize multiple rounds for the workout session such that a first round’s pacing session and resting period may be different from a subsequent or previous round.

The interval pacer application is adapted to enhance previous interval timer applications by providing a customizable pacer option which is virtually a fully customizable solution for a user to have an individualized exercise plan. The interoperation of the pacer with the interval timer enriches workout sessions by pushing the user to stick with the user-set pace for the user-designated period. The present implementation can also increase system performance since the entire switching workflow is automated after the user inputs the requisite parameters for the pacing sessions and resting periods.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative layered architecture of a computing device;

FIG. 2 shows an illustrative user interface displaying an interval pacer application;

FIG. 3 shows an illustrative diagram of parameters input into the interval pacer application;

FIG. 4 shows an illustrative user interface displaying the input parameters within the interval pacer application;

FIG. 5 shows an illustrative representation in which the input parameters can result in one or multiple sets of pacer and rest periods;

FIG. 6 shows an illustrative flowchart of a single pacer and rest set;

FIG. 7 shows an illustrative flowchart of multiple sets of pacers and rests;

FIG. 8 shows an illustrative implementation of the interval pacer application;

FIG. 9 shows an illustrative representation of pacer output mechanisms;

FIGS. 10 and 11 show illustrative flowcharts which may be performed by a computing device such as a smartphone, tablet computer, personal computer, smartwatch, HMD device, or dedicated timing device; and

FIG. 12 shows an illustrative block diagram of a computer system that may be used to implement the present automated pacer interval application.

Like reference numerals indicate like elements in the drawings. Elements are not drawn to scale unless otherwise indicated.

### DETAILED DESCRIPTION

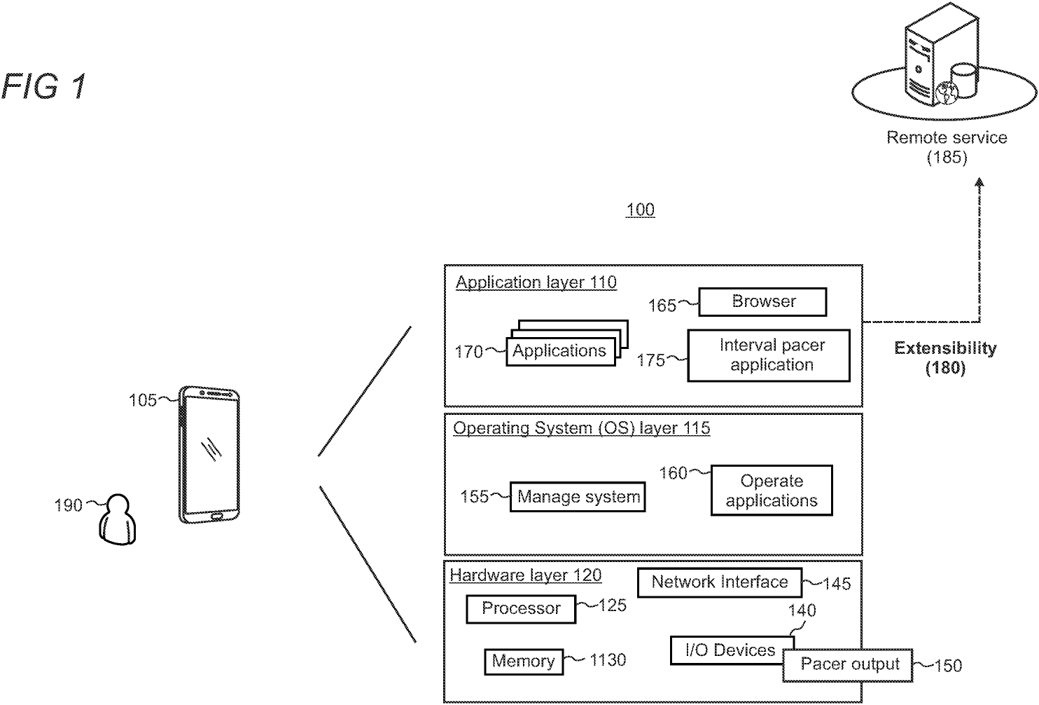

FIG. 1 shows an illustrative representation of a layered architecture 100 of a computing device 105 associated with a user 190. While a smartphone device is illustrated as the primary computing device on which the present system can be implemented, other computing devices can also utilize the present system, including smartwatches, tablet computers, head-mounted display (HMD) devices, personal or laptop computers, and dedicated timing devices that perform various and discrete timing applications (e.g., countdown, timer, interval timing, etc.). Thus, any reference to a computing device is exemplary, and other devices may utilize similar technology.

The computing devices 105 can include a hardware layer 120, operating system (OS) layer 115, and application layer 110. The hardware layer 115 provides an abstraction of the various hardware used by the computing device (e.g., input and output devices, networking and radio hardware, etc.) to the layers above it. In this illustrative example, the hardware layer supports processor(s) 125, memory 130, input/output devices 140 (e.g., a microphone, speakers, camera, touchscreen display, mechanical buttons, etc.), and a pacer output 150. The computing device may likewise include a network interface 145, such as a network interface card (NIC) that enables wired (e.g., Ethernet) or wireless communications to a router or other computing device. For example, one or more network interface devices may enable the transmission of WiFi signals to a router and be configured with Bluetooth® or NFC (Near Field Communication) capabilities.

The application layer 110 in this illustrative example supports various applications 170, including a web browser application 165 that may be utilized to access the Internet and the World Wide Web. An interval pacer application 175 may be instantiated on the device to perform the various functions described herein, such as receiving input parameters to customize the interval pacer and output at requisite intervals. The computing device may have extensibility 180 to remote services 185, such as websites and other applications.

Although only certain applications are depicted in FIG. 1, any number of applications can be utilized by the HMD device 105. The applications are often implemented using locally executing code. However, in some cases, these applications can rely on services and/or remote code execution provided by remote servers or other computing platforms such as those supported by a service provider or other cloud-based resources.

The OS layer 115 supports, among other operations, managing system 155 and operating applications/programs 160. In addition, the OS layer may interoperate with the application and hardware layers in order to perform various functions and features.

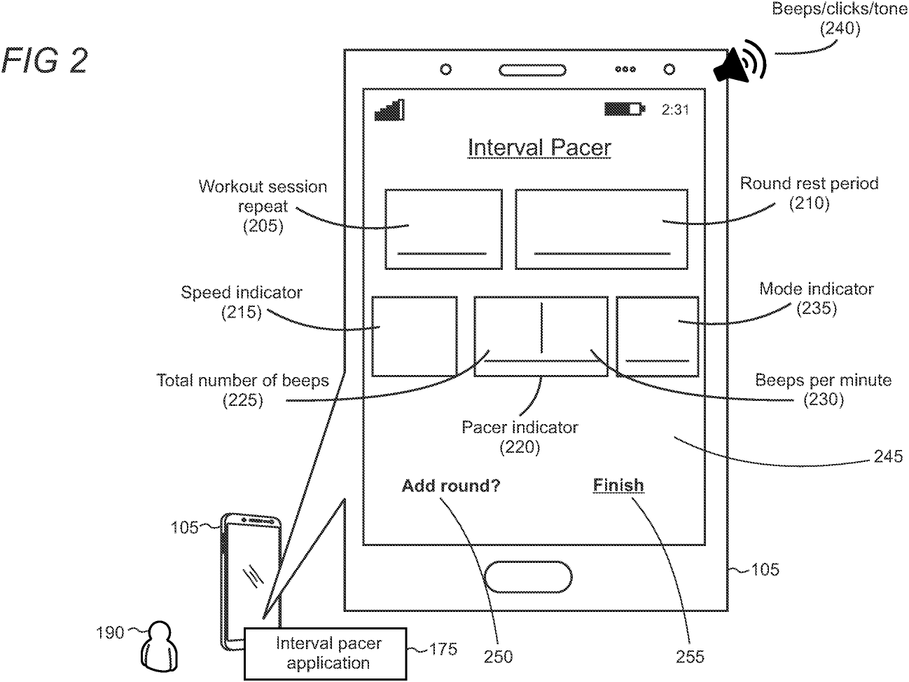

FIG. 2 shows an illustrative user interface 245 in which the interval pacer application 175 is displayed on the user’s computing device 105. The user interface may be shown upon opening the interval pacer application or may be a screen that the user is directed to after a start screen is presented.

The user interface 245 for the interval pacer application 175 shows various text boxes for the user to customize their workout session. Available text boxes configured to receive the user’s input include a number of times the user wishes to repeat an entire workout session 205, a rest period for a round 210, a pacer indicator 220, which includes a total number of beeps 225 and beeps per minute 230. The term “beeps” is used for exemplary purposes, and is generally referred to herein as “outputs” which can include clicks, beeps, tones, music, or vibratory feedback. A mode indicator 235 may be changed to different modes for the user, such as a straight interval timer (switches between a countdown for a workout and a resting period), a timer, a countdown timer, etc. In addition, the speed indicator 215 is used as a graphical representation of the speed at which the pacer is running, which may be correlated with the input parameters for the pacer indicator 220.

After inputting the various parameters, user 190 may select the “Add round?” button 250 to create another round for the workout session. The user may select “Finish” 255 when the user has finished entering one or more rounds of parameters. Multiple different workout sessions may be created and stored within the device’s memory or remotely stored, such as at the remote service 185 (FIG. 1).

The round rest period 210 and the pacer indicator 220 parameters may be unique to a specific round within a workout session. For example, a first-round may be configured with a five-second rest period and a pacer set at 20 beeps per minute, whereas a second round may have a rest period of 10 seconds and a pacer at 30 beeps per minute. The use of the term “beeps” is an exemplary output for the pacer, but other outputs may also be available, such as clicks, tones, music set to (or having) a specific tempo, etc. The interval pacer application 175 may leverage a speaker to output the beeps/clicks/tone, as representatively shown by numeral 240.

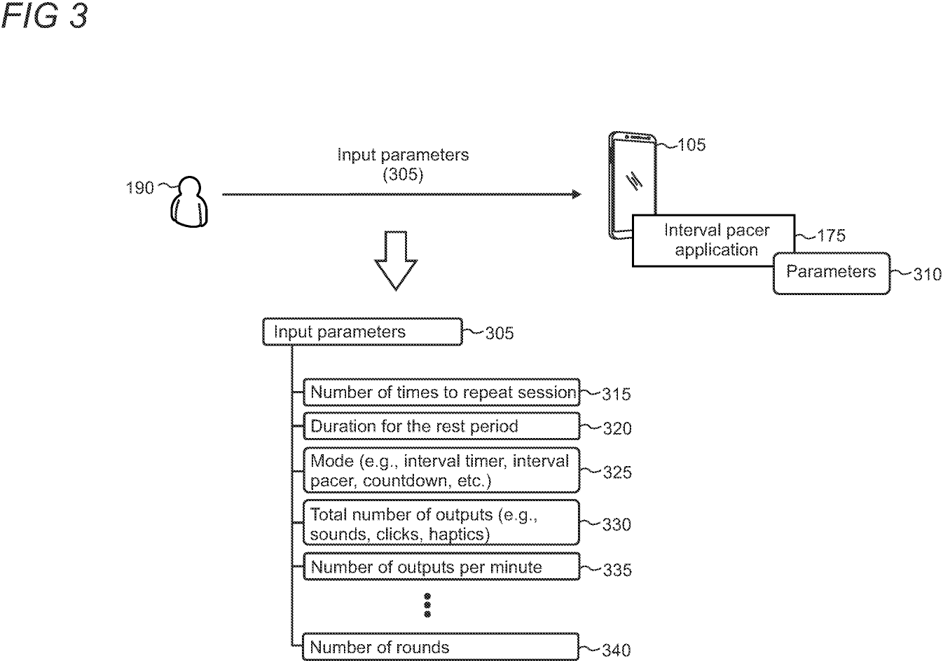

FIG. 3 shows an illustrative diagram in which the user 190 inputs parameters 305 into the interval pacer application 175 on the computing device 105. Once entered, the parameters 310 are set within the interval pacer application, either locally, remotely, or both. The input parameters 305 can include the number of times to repeat a workout session 315, a duration for the rest period 320, a mode (e.g., interval timer, interval pacer, countdown, etc.), a total number of outputs 330 (e.g., sounds, clicks, vibrations, etc.), a number of outputs per minute 335, and a number of rounds 340, among other parameters.

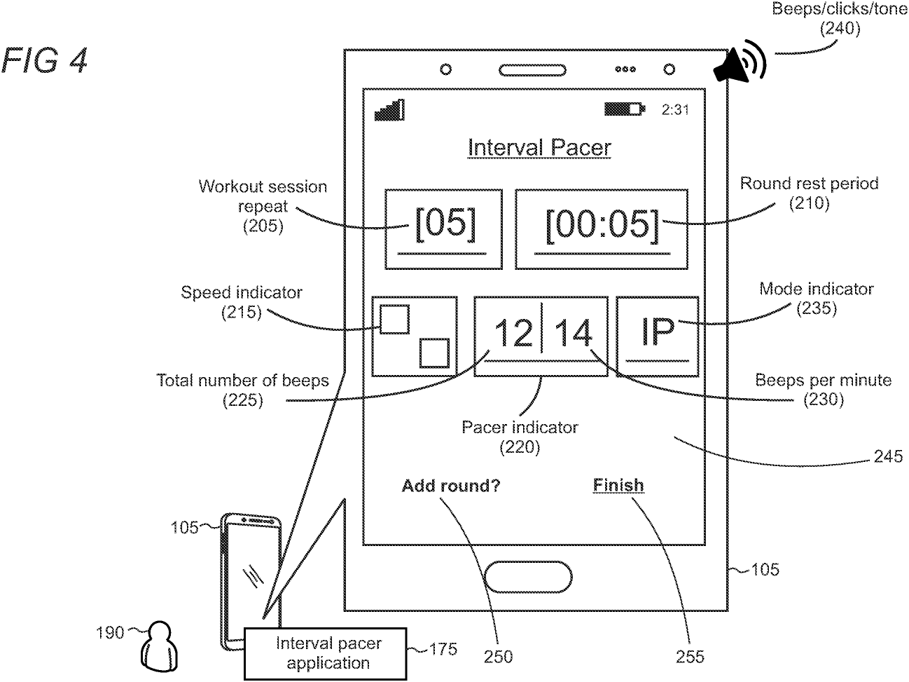

FIG. 4 shows the illustrative user interface 245 in which the user’s input parameters 305 are propagated in the interval pacer application 175. The user’s inputs indicate that the workout session will repeat five times 205, the round rest period is five seconds 210, the total number of beeps is 12 225, the beeps per minute is 14 230, and the mode is set to IP (interval pacer) 235.

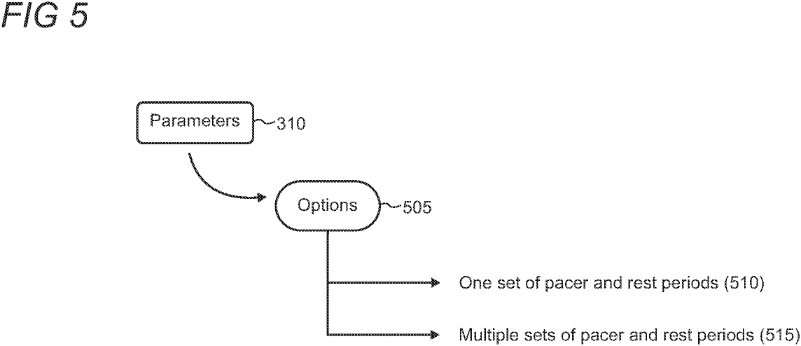

FIG. 5 shows an illustrative representation in which the parameters 310 input into the interval pacer application 175 can be configured in at least two options 505. The user may input and utilize one set of pacer and rest periods 510, or the user may input and utilize multiple sets of pacers and rest periods 515. The multiple sets option may be selected responsive to the user selecting the “Add round?” button 250 (FIGS. 2 and 4).

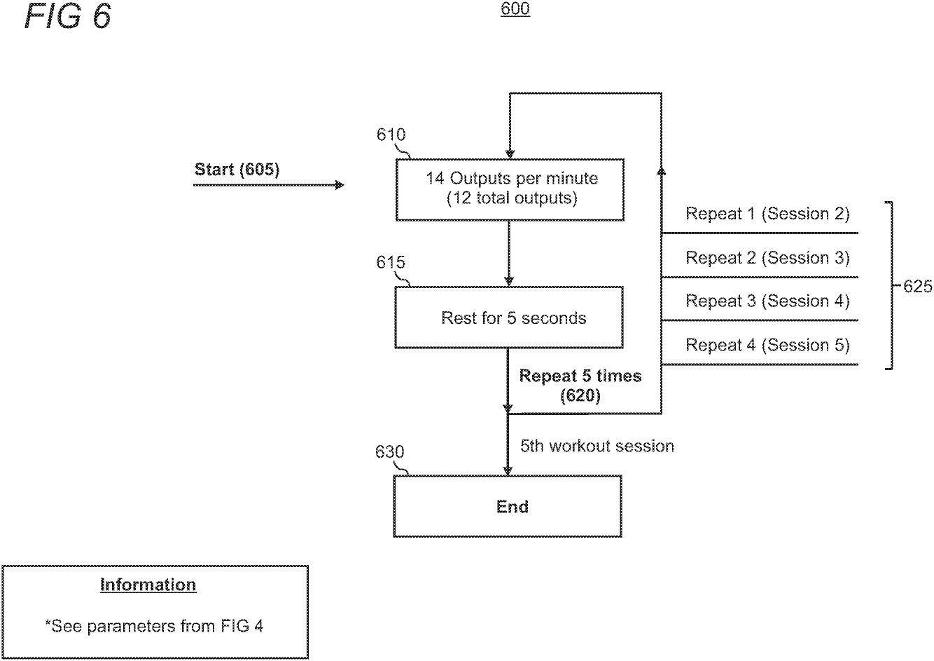

FIG. 6 shows an illustrative flowchart 600 in which a single round having a pacer and rest period is implemented. The workout session starts at step 605. In step 610, the interval pacer application provides 14 outputs per minute with 12 total outputs. In step 615, after outputting the 12 total outputs, the interval pacer application rests for five seconds. The interval pacer application then repeats this sequence four more times, as representatively shown by numeral 625, so that the complete workout session is repeated five times total. In step 630, after completion of the fifth workout session, the interval pacer application ends its process.

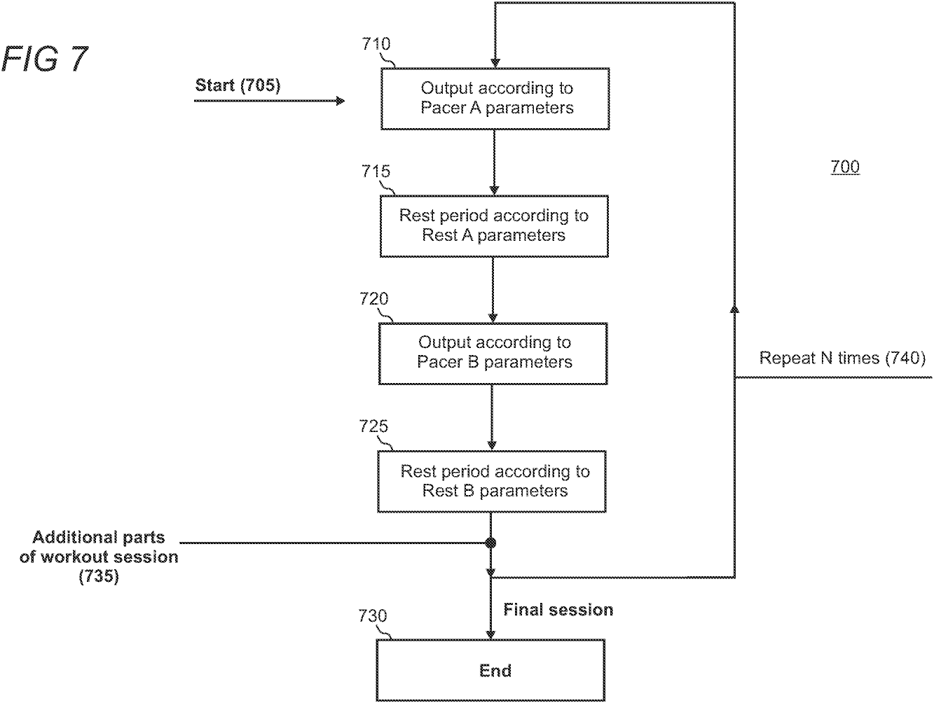

FIG. 7 shows an illustrative flowchart 700 in which multiple rounds, each having a unique pacer and rest period, are implemented within a single workout session. FIG. 7 is based on a scenario in which the user selected the “Add round?” 250 button at least once (FIGS. 2 and 4). The workout session starts at step 705. In step 710, the interval pacer application 175 provides an output according to pacer A parameters. Pacer A parameters may be a first customized pacer rate for a first round. The pacer rate may be determined based on the user’s desired output/beep per minute, and the total number of outputs are based on the user’s input number. In step 715, the interval pacer application executes a rest period according to Rest A parameters, which may have likewise been input by the user for a first-round in the workout session. In step 720, the interval pacer application provides an output according to Pacer B parameters, which a user may have customized for a second round in the workout session. The second round begins after the first round ends, which is after the first round’s rest period (Step 715). In step 725, the interval pacer application executes a rest period according to Rest B parameters, which the user input into the application for the second round in the workout session.

While FIG. 7 shows two rounds, Rounds A and B, for the workout session, additional rounds of the workout session may have been input by the user as well, as representatively shown by numeral 735. Thus, the user could continue to create additional rounds, such as rounds three, four, etc. In typical implementations, there may be no limit to the number of rounds a user can enter for a workout session. In other embodiments, such as a dedicated and standalone timing device with limited memory capabilities, the application may restrict the user to a certain number of rounds per workout session, such as ten rounds.

The interval pacer application 175 may repeat the workout session N number of times, based on the user’s desired and entered input (FIGS. 2 and 4). After the interval pacer application repeats the workout session’s sets of pacers and rest periods according to the set number of times to repeat for the workout session, the interval pacer application ends on the final workout session, as representatively shown by numeral 730.

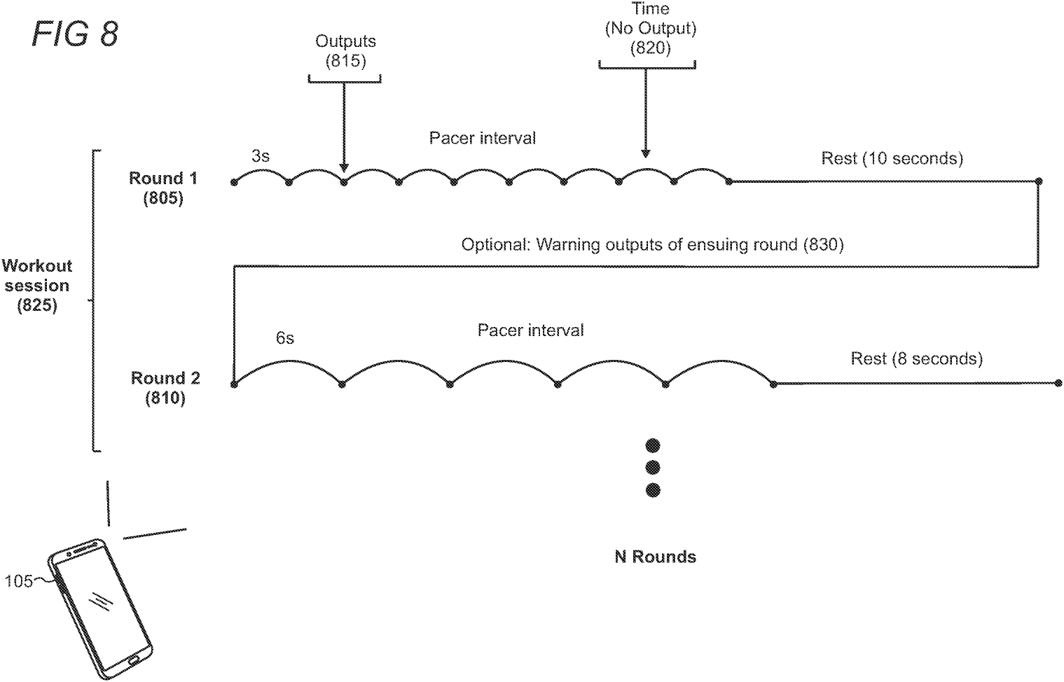

FIG. 8 shows an illustrative representation of the computing device’s actions while executing a configured workout session 825. For example, during a first-round 805, the computing device provides an output 815 every three seconds for the pacer interval. The three seconds may have been calculated according to the user’s input of desired outputs/beeps per minute (FIGS. 2 and 4, reference numeral 230). In between outputs is the passage of time during which no outputs are provided; that is, the device may be silent. Alternatively, certain sounds or other customizations may be provided in between outputs, but these would not interfere with the user’s desired tempo. For example, when longer time is available between outputs, music or inspirational passages may be played. Once the device outputs the user’s total number for the first round, the smartphone device enters a rest period for 10 seconds according to the user’s previously entered instructions.

After the rest period of 10 seconds is complete, the computing device may immediately start providing outputs according to the second round’s parameters. However, in alternative implementations, the interval pacer application may end the prior rest period with a warning of the start of the upcoming round’s pacer, as representatively shown by numeral 830. For example, the last three seconds of the 10 second rest period may be used to output three beeps or other outputs one second apart, thereby warning the user that the next pacer is about to begin. The next pacer may be the next round’s pacer or, in scenarios in which a single round is repeated, the first round’s pacer. Alternatively, a warning output of the next round may occur after the rest period’s duration expired. Thus, the interval pacer application may provide, for example, a two or three-second warning output in addition to the rest period that indicates to the user of the subsequent round’s pacer session.

In round 2 810, the computing device 105 provides outputs six seconds apart, and the device enters a rest period after the set number of outputs is provided. Here, the rest period is eight seconds. The computing device may continue to provide outputs based on a pacer, execute rest periods, and optionally provide warnings to the user for N number of rounds until the workout session and the desired number of session repeats are complete. The ability to customize each round’s parameters enables the user to create a multi-point workout. For example, the first round’s faster pacer rate may be used for sit-ups, and the second round’s relatively slower pacer may be used for pull-ups. The interval pacer application’s customizability is adapted to accommodate the different exercises and user abilities that can change across users and workouts.

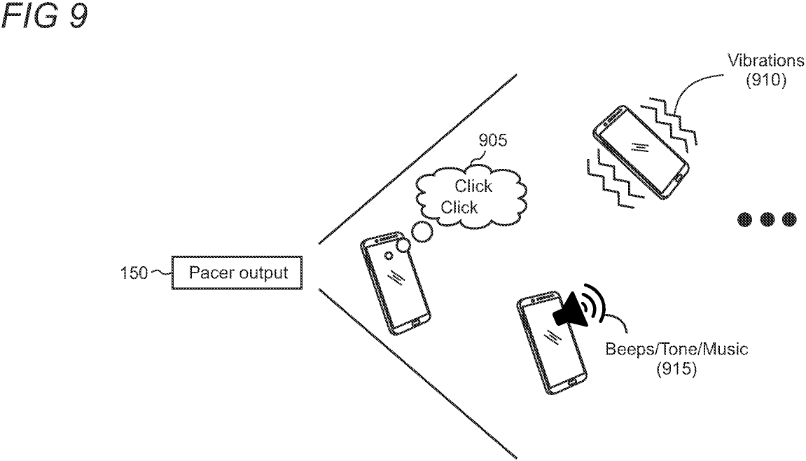

FIG. 9 shows an illustrative representation in which the types of pacer output 150 provided by the computing device 105 may vary depending on the device’s implementation and hardware and software capabilities. The pacer output may be the output that occurs at set intervals, such as every three seconds or six seconds (FIG. 8). Exemplary outputs can include any one or more of clicks 905, beeps/tones/music 915, or vibrations 910.

The downbeat outputs may alternatively be customized by the user, such as downloaded from a remote service. Songs that fit within the user’s pacer parameters may be presented on the user interface for user-selection as an option instead of a beep, click, tone, etc. For example, if the tempo of the song Survivor corresponds to the rate associated with the user’s entered parameters for the pacer, then the user may select that song to play. The song may play instead of or in addition to (and overlap with) the other outputs, such as a beep, vibrations feedback, tone, click, etc. Outputting the song simultaneously with the beats may enable the user to stay on track while enjoying the music. Music may be selected based on a given song’s tempo corresponding to the user’s set pace. Alternatively, a song’s tempo may be sped up or slowed down to accommodate the user’s set pace.

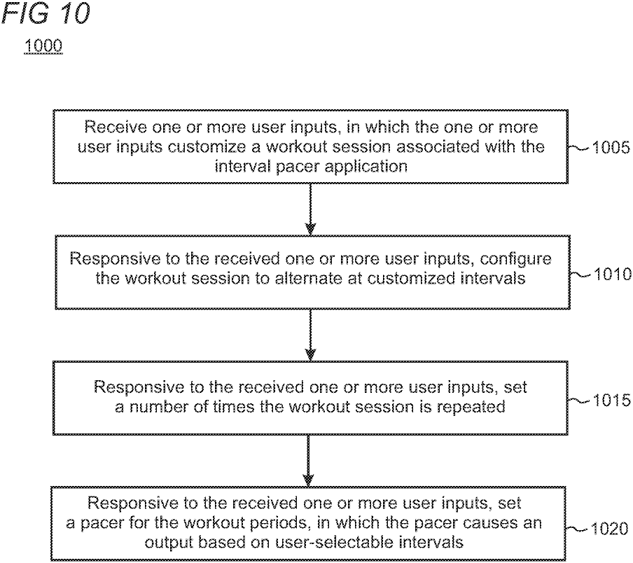

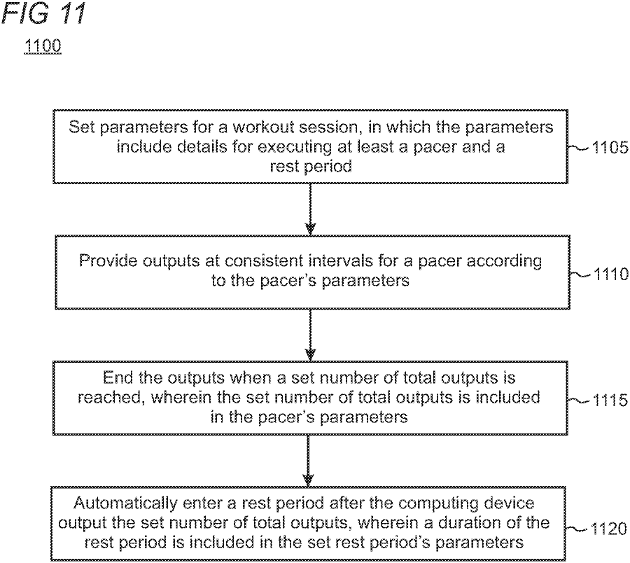

FIGS. 10 and 11 show illustrative flowcharts that a computing device may implement, such as a smartphone, tablet computer, personal computer, laptop computer, or a dedicated timing device, among other device types. The computing device may implement, for example, the interval pacer application 175 as discussed herein.

In step 1005, in FIG. 10, the computing device receives one or more user inputs, in which the one or more user inputs customize a workout session associated with the interval pacer application. In step 1010, the computing device, responsive to the received one or more user inputs, _{configures} the workout session to alternate at customized intervals. In step 1015, responsive to the received one or more inputs, the computing device sets a number of times the workout session is repeated. In step 1020, responsive to the received one or more user inputs, the computing device sets a pacer for the workout periods, in which the pacer causes an output based on user-selectable intervals.

In step 1105, in FIG. 11, the computing device sets parameters for a workout session, in which the parameters include details for executing at least a pacer and a rest period. In step 1110, the computing device provides outputs at consistent intervals for a pacer according to the pacer’s parameters. The provided outputs may be any one or more of an auditory beep, click, tone, music, or vibratory feedback at the device. In step 1115, the computing device ends the outputs when a set number of total outputs is reached, wherein the set number of total outputs is included in the pacer’s parameters. In step 1120, the computing device automatically enters a rest period after the computing device outputs the set number of total outputs, wherein a duration of the rest period is included in the set rest period’s parameters.

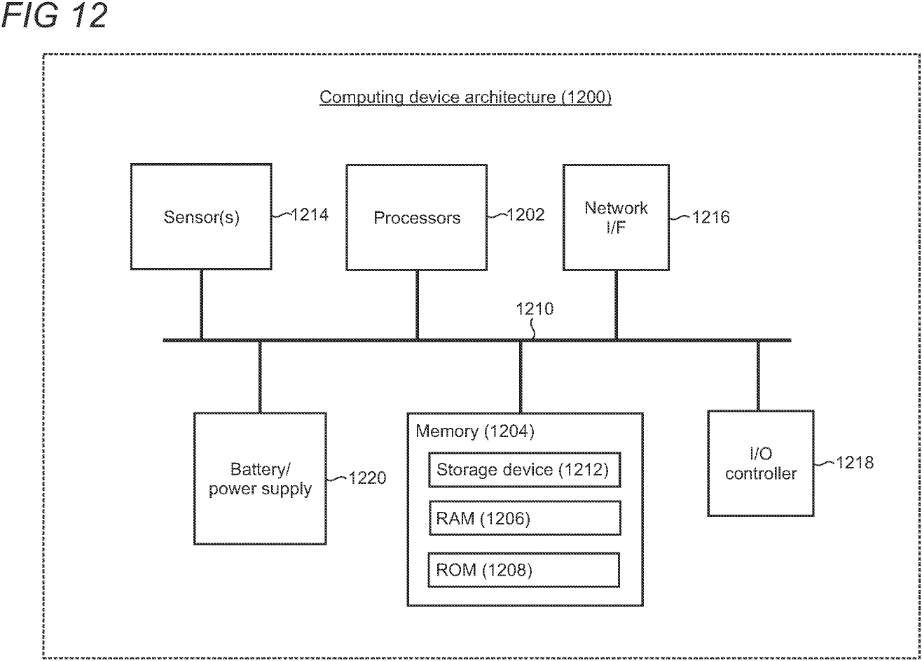

FIG. 12 shows an illustrative architecture 1200 for a device, such as a smartphone, tablet, laptop computer, or access device, capable of executing the various features described herein. The architecture 1200 illustrated in FIG. 12 includes one or more processors 1202 (e.g., central processing unit, dedicated AI chip, graphics processing unit, etc.), a system memory 1204, including RAM (random access memory) 1206, ROM (read-only memory) 1208, and long-term storage devices 1212. The system bus 1210 operatively and functionally couples the components in the architecture 1200. A basic input/output system containing the basic routines that help transfer information between elements within the architecture 1200, such as during startup, is typically stored in the ROM 1208. The architecture 1200 further includes a long-term storage device 1212 for storing software code or other computer-executed code utilized to implement applications, the file system, and the operating system. The storage device 1212 is connected to the processor 1202 through a storage controller (not shown) connected to bus 1210. The storage device 1212 and its associated computer-readable storage media provide non-volatile storage for the architecture 1200. Although the description of computer-readable storage media contained herein refers to a long-term storage device, such as a hard disk or CD-ROM drive, it may be appreciated by those skilled in the art that computer-readable storage media can be any available storage media that can be accessed by the architecture 1200, including solid-state drives and flash memory.

By way of example, and not limitation, computer-readable storage media may include volatile and non-volatile, removable and non-removable media implemented in any method or technology to store information such as computer-readable instructions, data structures, program modules, or other data. Thus, for example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1200.

According to various embodiments, the architecture 1200 may operate in a networked environment using logical connections to remote computers through a network. The architecture 1200 may connect to the network through a network interface unit 1216 connected to the bus 1210. It may be appreciated that the network interface unit 1216 also may be utilized to connect to other types of networks and remote computer systems. The architecture 1200 also may include an input/output controller 1218 for receiving and processing input from a number of other devices, including a keyboard, mouse, touchpad, touchscreen, control devices such as buttons and switches, or electronic stylus (not shown in FIG. 12). Similarly, the input/output controller 1218 may provide output to a display screen, user interface, a printer, or other type of output device (also not shown in FIG. 12).

It may be appreciated that any software components described herein may, when loaded into the processor 1202 and executed, transform the processor 1202 and the overall architecture 1200 from a general-purpose computing system into a special-purpose computing system customized to facilitate the functionality presented herein. The processor 1202 may be constructed from any number of transistors or other discrete circuit elements, which may individually or collectively assume any number of states. More specifically, the processor 1202 may operate as a finite-state machine in response to executable instructions contained within the software modules disclosed herein. These computer-executable instructions may transform the processor 1202 by specifying how the processor 1202 transitions between states, thereby transforming the transistors or other discrete hardware elements constituting the processor 1202.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1200 in order to store and execute the software components presented herein. It also may be appreciated that the architecture 1200 may include other types of computing devices, including wearable devices, handheld computers, embedded computer systems, smartphones, PDAs, and other types of computing devices known to those skilled in the art. It is also contemplated that the architecture 1200 may not include all of the components shown in FIG. 12, may include other components that are not explicitly shown in FIG. 12, or may utilize an architecture completely different from that shown in FIG. 12.

Various exemplary embodiments are implemented and disclosed herein. In one exemplary embodiment, disclosed is a computing device configured with an interval pacer application, comprising: one or more output mechanisms; one or more processors; one or more hardware-based memory devices storing computer-readable instructions which, when executed by the one or more processors, causes the computing device to: receive one or more user inputs, in which one or more user inputs customize a workout session associated with the interval pacer application, the interval pacer application adapted to receive and store multiple distinct workout sessions; responsive to the received one or more user inputs, configure the workout session to alternate at customized intervals, in which the workout session alternates between a workout period and a resting period; responsive to the received one or more user inputs, set a number of times the workout session is repeated; and responsive to the received one or more user inputs, set a pacer for the workout periods, in which the pacer causes an output at the one or more output mechanisms based on user-selectable intervals.

In another example, the workout session is comprised of one or more rounds, in which each round includes a workout period and a resting period, wherein one or both of a given round’s workout period or resting period are configured with different parameters. As a further example, the executed instructions further cause the computing device to, responsive to receiving the one or more user inputs, set a number of outputs for the pacer. In another example, the executed instructions further cause the computing device to, responsive to receiving the one or more user inputs, set a rate at which the pacer outputs the set number of outputs. As a further example, the rate is based on a number of beats per minute. In another example, further comprising displaying a speed indicator which visually shows the rate. As a further example, the workout session includes multiple rounds, each round having one pacer workout period and one resting period. As a further example, a subsequent round’s workout period begins immediately after a prior round’s resting period expires.

In another exemplary embodiment, disclosed is a method, performed by a computing device, to execute an interval pacer application for a user’s workout, comprising: setting parameters for a workout session, in which the parameters include details for executing at least a pacer and a rest period; providing outputs at consistent intervals for a pacer according to the set pacer’s parameters; ending the outputs when a set number of total outputs is reached, wherein the set number of total outputs is included in the pacer’s parameters; and automatically entering a rest period after the computing device output the set number of total outputs, wherein a duration of the rest period is included in the set rest period’s parameters.

As another example, further comprising: automatically repeating the provided outputs at the consistent intervals for the pacer after the duration for the rest period expires, and then entering the rest period again after the set number of total outputs is reached. In another example, the outputs include any one or more of auditory clicks, beeps, tones, music, or device vibrations. In another example, the workout session includes multiple rounds, each round having a pacer and a rest period, wherein a subsequent round’s pacer begins after a prior round’s rest period expires. As a further example, a warning is output to the user during or after expiry of each round’s rest period. As another example, each round’s pacer and rest period are configured with its own unique set of parameters.

In another exemplary embodiment, disclosed is one or more hardware-based computer-readable memory devices storing instructions which, when executed by one or more processors disposed in a computing device, cause the computing device to: set parameters for a workout session, in which the parameters include details for executing at least a pacer and a rest period; provide outputs at consistent intervals for a pacer according to the set pacer’s parameters; end the outputs when a set number of total outputs is reached, wherein the set number of total outputs is included in the pacer’s parameters; and automatically enter a rest period after the computing device output the set number of total outputs, wherein a duration of the rest period is included in the set rest period’s parameters.

In another example, the executed instructions further cause the computing device to: automatically repeat the provided outputs at the consistent intervals for the pacer after the duration for the rest period expires, and then entering the rest period again after the set number of total outputs is reached. As a further example, the outputs include any one or more of auditory clicks, beeps, tones, music, or device vibrations. As another example, the workout session includes multiple rounds, each round having a pacer and a rest period, wherein a subsequent round’s pacer begins after a prior round’s rest period expires. As a further example, a warning is output to the user during or after expiry of each round’s rest period. As another example, each round’s pacer and rest period are configured with its own unique set of parameters.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computing device configured with an interval pacer application, comprising:
one or more output mechanisms;
one or more processors;
one or more hardware-based memory devices storing computer-readable instructions which, when executed by the one or more processors, causes the computing device to:
receive one or more user inputs, in which one or more user inputs customize a workout session associated with the interval pacer application, the interval pacer application adapted to receive and store multiple distinct workout sessions;
responsive to the received one or more user inputs, configure the workout session to alternate at customized intervals, in which the workout session alternates between a workout period and a resting period;
responsive to the received one or more user inputs, set a number of times the workout session is repeated; and
responsive to the received one or more user inputs, set a pacer for the workout periods, in which the pacer causes an output at the one or more output mechanisms based on user-selectable intervals.

2. The computing device of claim 1, wherein the workout session is comprised of one or more rounds, in which each round includes a workout period and a resting period, wherein one or both of a given round’s workout period or resting period are configured with different parameters.

3. The computing device of claim 1, wherein the executed instructions further cause the computing device to, responsive to receiving the one or more user inputs, set a number of outputs for the pacer.

4. The computing device of claim 3, wherein the executed instructions further cause the computing device to, responsive to receiving the one or more user inputs, set a rate at which the pacer outputs the set number of outputs.

5. The computing device of claim 4, wherein the rate is based on a number of beats per minute.

6. The computing device of claim 5, further comprising displaying a speed indicator which visually shows the rate.

7. The computing device of claim 4, wherein the workout session includes multiple rounds, each round having one pacer workout period and one resting period.

8. The computing device of claim 7, wherein a subsequent round’s workout period begins immediately after a prior round’s resting period expires.

9. A method, performed by a computing device, to execute an interval pacer application for a user’s workout, comprising:
setting parameters for a workout session, in which the parameters include details for executing at least a pacer and a rest period;
providing outputs at consistent intervals for a pacer according to the set pacer's parameters;
ending the outputs when a set number of total outputs is reached, wherein the set number of total outputs is included in the pacer’s parameters; and
automatically entering a rest period after the computing device output the set number of total outputs, wherein a duration of the rest period is included in the set rest period’s parameters.

10. The method of claim 9, further comprising:
automatically repeating the provided outputs at the consistent intervals for the pacer after the duration for the rest period expires, and then entering the rest period again after the set number of total outputs is reached.

11. The method of claim 9, wherein the outputs include any one or more of auditory clicks, beeps, tones, music, or device vibrations.

12. The method of claim 9, wherein the workout session includes multiple rounds, each round having a pacer and a rest period, wherein a subsequent round's pacer begins after a prior round’s rest period expires.

13. The method of claim 12, wherein a warning is output to the user during or after expiry of each round’s rest period.

14. The method of claim 13, wherein each round’s pacer and rest period are configured with its own unique set of parameters.

15. One or more hardware-based computer-readable memory devices storing instructions which, when executed by one or more processors disposed in a computing device, cause the computing device to:
set parameters for a workout session, in which the parameters include details for executing at least a pacer and a rest period;
provide outputs at consistent intervals for a pacer according to the set pacer's parameters;
end the outputs when a set number of total outputs is reached, wherein the set number of total outputs is included in the pacer’s parameters; and
automatically enter a rest period after the computing device output the set number of total outputs, wherein a duration of the rest period is included in the set rest period’s parameters.

16. The one or more hardware-based computer-readable memory devices of claim 15, wherein the executed instructions further cause the computing device to:
automatically repeat the provided outputs at the consistent intervals for the pacer after the duration for the rest period expires, and then entering the rest period again after the set number of total outputs is reached.

17. The one or more hardware-based computer-readable memory devices of claim 15, wherein the outputs include any one or more of auditory clicks, beeps, tones, music, or device vibrations.

18. The one or more hardware-based computer-readable memory devices of claim 15, wherein the workout session includes multiple rounds, each round having a pacer and a rest period, wherein a subsequent round’s pacer begins after a prior round's rest period expires.

19. The one or more hardware-based computer-readable memory devices of claim 18, wherein a warning is output to the user during or after expiry of each round's rest period.

20. The one or more hardware-based computer-readable memory devices claim 19, wherein each round’s pacer and rest period are configured with its own unique set of parameters.
